(19) United States
(12) Patent Application Publication
(10) Pub. No.: US 2025/0031694 A1
(43) Pub. Date: Jan. 30, 2025

(54) AGRICULTURAL CHEMICAL COMPOSITION AND METHOD FOR PRODUCING SAME

(71) Applicant: MITSUI CHEMICALS CROP & LIFE SOLUTIONS, INC., Tokyo (JP)

(72) Inventors: Nariaki SHIZUYA, Chuo-ku, Tokyo (JP); Haruka FUKUDA TAKEUCHI, Chuo-ku, Tokyo (JP); Atsushi SATO, Chuo-ku (JP)

(73) Assignee: MITSUI CHEMICALS CROP & LIFE SOLUTIONS, INC., Tokyo (JP)

(21) Appl. No.: 18/717,122

(22) PCT Filed: Dec. 6, 2022
(86) PCT No.: PCT/JP2022/044826

§ 371 Date: Jun. 6, 2024

(30) Foreign Application Priority Data
Dec. 7, 2021 (JP) 2021-198600

(51) Int. Cl. A01N 25/10; A01N 25/04; A01N 25/12

(52) U.S. Cl. CPC A01N 25/10; A01N 25/04; A01N 25/12

(57) ABSTRACT

An agrochemical composition comprising: two or more selected from the group consisting of the following three:
a resin emulsion;
a surface-treated kaolin and
a combination of an organically modified bentonite and an oil; and

an agrochemical active ingredient.

### TECHNICAL FIELD

The present invention relates to an agricultural chemical composition and a method for producing the same.

### BACKGROUND ART

Known forms of agrochemicals (agricultural chemical) include dust formulations, granules, wettable powders, water-solubles, emulsifiable concentrates, liquid formulations, oil solutions, and the like. Among others, granules are widely used in Japan, because of characteristics such as reduction in amount scattered during application and relatively easy measurement of the amount. In addition, the recent technical progress made by machinery manufacturers have led to development of, for example, germinator box-treating apparatuses and rice transplanter-agrochemical applicators which use granules for paddy-rice cultivation, and the like. In this respect, granules are, in particular, required to have all-around properties in various aspects such as a low phytotoxicity (agrochemical-induced adverse effect) on crop plants (for example, rice plants), long-term residual efficacy of the agrochemical, good manufacturability and high efficiency during manufacturing process, and spraying suitability for mechanical sprayers.

Regarding the above-described low phytotoxicity on crop plants and long-term residual efficacy of the agrochemical, some agrochemical compositions and methods for producing the same have been examined so far with the intention of controlling the rapid release of an agrochemical active ingredient at an initial stage and imparting these properties to an agrochemical composition. For example, Japanese Unexamined Patent Application Publication No. 2001-233706 (PTL 1) describes a method for producing sustained-release agrochemical granules, comprising mixing and granulating an agrochemical active ingredient, a water repellent, and carboxymethyl cellulose, and discloses waxes and hydrophobic silica as the water repellent. Meanwhile, for example, Japanese Unexamined Patent Application Publication No. Hei 8-143402 (PTL 2) describes, as sustained-release agrochemical granules, agrochemical granules obtained by granulating a mixture of particles of a solid agrochemical active ingredient, particles of amorphous silica, and an auxiliary agent component. Moreover, for example, Japanese Unexamined Patent Application Publication No. 2010-18527 (PTL 3) describes sustained-release agrochemical granules comprising an agrochemical active ingredient, sepiolite, a binder, and a surfactant, intended to control the release of the agrochemical active ingredient. In addition, for example, Japanese Unexamined Patent Application Publication No. 2011-6396 (PTL 4) describes, as a controlled release-type agrochemical composition, an agrochemical composition comprising an agrochemical active ingredient, a fatty acid and/or fatty acid derivative, a poorly water-soluble polysaccharide, and an inorganic substance.

### CITATION LIST

### Patent Literature

[PTL 1] Japanese Unexamined Patent Application Publication No. 2001-233706
[PTL 2) Japanese Unexamined Patent Application Publication No. Hei 8-1.43402
[PTL 3]Japanese Unexamined Patent Application Publication No. 2010-18527
[PTL 4] Japanese Unexamined Patent Application Publication No. 2011-6396

### SUMMARY OF INVENTION

### Technical Problem

However, the constitutions of the conventional agrochemical compositions and the methods for producing the same have problems such as necessity of a specialized machine, complicated steps, and the difficulty of granulation especially in the case of granules containing an agrochemical active ingredient having a high water solubility. Moreover, the present inventors have found that the conventional agrochemical compositions have problems in that suppression of the rapid release of the agrochemical active ingredient, especially, the above-described agrochemical active ingredient having high water solubility at an initial stage is still insufficient, that the excessively released agrochemical active ingredient leads to a phytotoxicity on the crop plants (poor growth or the like), and that the long-term residual efficacy of the agrochemical active ingredient is impaired.

The present invention has been made in view of the above-described problems of the conventional techniques, and an object of the present invention is to provide a sustained-release agrochemical composition which is excellent in sustained-release properties and from which rapid release of the agrochemical active ingredient into water at an initial stage is sufficiently suppressed, as well as a production method that makes it possible to easily and highly efficiently obtain sustained-release agrochemical granules which are excellent in sustained-release properties and from which rapid release of the agrochemical active ingredient into water at an initial stage is sufficiently suppressed.

### Solution to Problem

The present inventors have conducted intensive studies to achieve the above-described object, and consequently have found that a constitution comprising two or more selected from the group consisting of the following three: a resin emulsion, a surface-treated kaolin, and a combination of an organically modified bentonite and an oil, and an agrochemical active ingredient makes it possible to obtain an agrochemical composition which is excellent in sustained-release properties and from which rapid release of the agrochemical active ingredient into water at an initial stage is sufficiently suppressed, so that the phytotoxicity of the agrochemical active ingredient on crop plants can be sufficiently reduced, and the persistence of an effect of the agrochemical active ingredient (long-term residual efficacy) can be improved. In addition, it has also been found that such a constitution makes it possible to produce agrochemical granules having an adequate particle size easily and highly efficiently only by mixing and granulating the above-described components. These findings have led to the completion of the present invention.

Aspects of the present invention achieved based on these findings are as follows.
[1] An agrochemical composition comprising:
   two or more selected from the group consisting of the following three:
      a resin emulsion;
      a surface-treated kaolin; and
      a combination of an organically modified bentonite and an oil; and
   an agrochemical active ingredient.
[2] The agrochemical composition according to [1], wherein the resin emulsion is an acrylic resin emulsion.
[3] The agrochemical composition according to [1] or [2], wherein
   the surface-treated kaolin is a kaolin surface-treated with a silane.
[4] The agrochemical composition according to any one of [1] to [3], wherein
   the organically modified bentonite is a bentonite surface-treated with a quaternary ammonium compound.
[5] The agrochemical composition according to any one of [1] to [4], wherein
   the oil is at least one selected from the group consisting of hydrocarbon-based oils and vegetable oils.
[6] The agrochemical composition according to any one of [1] to [5], which comprises an agrochemical active ingredient having a water solubility at 20 to 25° C. of 50 g/L or lower as the agrochemical active ingredient.
[7] The agrochemical composition according to any one of [1] to [6], which comprises at least one selected from the group consisting of flupyrimin, probenazole, thiamethoxam, imidacloprid, tebufloquin, pretilachlor, and agrochemically acceptable acid addition salts thereof as the agrochemical active ingredient.
[8] The agrochemical composition according to any one of [1] to [7], further comprising at least one selected from the group consisting of surfactants and fillers.
[9] The agrochemical composition according to any one of [1] to [8], which is in the form of granules.
[10] A method for producing the agrochemical composition according to [9], comprises a step of mixing and granulating two or more selected from the group consisting of the following three:
   the resin emulsion;
   the surface-treated kaolin; and
   the combination of the organically modified bentonite and the oil;
with the agrochemical active ingredient.
[11] A method for producing the agrochemical composition according to [9], comprises:
   a granulation step of mixing and granulating two or more selected from the group consisting of the following three:
      the resin emulsion;
      the surface-treated kaolin; and
      the combination of the organically modified bentonite and the oil; and
   a step of introducing the agrochemical active ingredient into a granulated material obtained in the granulation step.

### Advantageous Effects of Invention

According to the present invention, it is possible to provide a sustained-release agrochemical composition which is excellent in sustained-release properties and from which rapid release of the agrochemical active ingredient into water at an initial stage is sufficiently suppressed, and a production method that makes it possible to easily and highly efficiently obtain sustained-release agrochemical granules which are excellent in sustained-release properties and from which rapid release of the agrochemical active ingredient into water at an initial stage is sufficiently suppressed.

### DESCRIPTION OF EMBODIMENTS

Hereinafter, the present invention will be described in detail based on preferred embodiments thereof.

### <Agrochemical Composition>

An agrochemical composition of the present invention comprises:
two or more selected from the group consisting of the following three:
   a resin emulsion;
   a surface-treated kaolin; and
   a combination of an organically modified bentonite and an oil; and
an agrochemical active ingredient.

### (Agrochemical Active Ingredient)

The agrochemical active ingredient according to the present invention is not particularly limited, and may be a conventional compound known as a pesticide, a microbicide, a herbicide, a plant growth control agent, or the like. Examples of the agrochemical active ingredient include compounds described in “The Pesticide Manual, 17th Edition (Publisher: The British Crop Protection Council) “or “SHIBUYA INDEX, 2014, (Publisher: SHIBUYA INDEX RESEARCH GROUP). One of these agrochemical active ingredients or a combination of two more thereof may be employed. Of these agrochemical active ingredients, the agrochemical active ingredient preferably contains at least one selected from the group consisting of pesticides, microbicides, herbicides, and plant growth control agents, and more preferably is at least one selected from the above-described group, because the agrochemical composition of the present invention can be excellent in sustained-release properties and can retain its effect for a long period. In addition, for example, to reduce an agrochemical-induced adverse effect on plants simultaneously, it is preferable that at least one selected from the group consisting of pesticides and microbicides be contained as the agrochemical active ingredient.

More preferred examples of the agrochemical active ingredient according to the present invention include organic phosphate ester-based compounds, carbamate-based compounds, nereistoxin derivatives, organochlorine compounds, pyrethroid-based compounds, benzoylurea-based compounds, juvenile hormone-like compounds, molting hormone-like compounds, neonicotinoid-based compounds, neuronal sodium channel blockers, insecticidal macrocyclic lactones, γ-aminobutyric acid (GABA) antagonists, ryanodine receptor-acting compounds, insecticidal ureas, BT agents, pathogenic insect virus agents, polyether-based antibiotics, thiamine antagonists, and sulfa drug•folic acid antagonist combination. The agrochemical active ingredient may be one of these examples or a combination of two more thereof.

More specific examples of the pesticide include organic phosphate ester-based compounds such as acephate, dichlorvos, PN, fenitrothion, fenamiphos, prothiofos, profenofos, pyraclofos, chlorpyrifos-methy, diazinon, fosthiazate, imicyafos, and phorate; carbamate-based compounds such as methomyl, thiodicarb, aldicarb, oxamyl, propoxur, carbaryl, fenobucarb, ethiofencarb, fenothiocarb, pirimicarb, carbofuran, carbosulfan, and benfuracarb; nereistoxin derivatives such as cartap and thiocyclam; organochlorine compounds such as dicofol and tetradifon; pyrethroid-based compounds such as permethrin, tefluthrin, cypermethrin, tralomethrin, deltamethrin, cyhalothrin, fenvalerate, fluvalinate, etofenprox, silafluofen, and cyhalothrin; benzoylurea-based compounds such as diflubenzuron, teflubenzuron, flufenoxuron, and chlorfluazuron; juvenile hormone-like compounds such as methoprene, hydroprene, and kinoprene; molting hormone-like compounds such as chromafenozide; nicotinic acetylcholine receptor agonists (neonicotinoid-based compounds) such as imidacloprid, clothianidin, thiamethoxam, acetamiprid, nitenpyram, thiacloprid, dinotefuran, sulfoxaflor, flupyradifurone, flupyrimin, dicloromezotiaz, triflumezopyrim, and fenmezoditiaz; diamide compounds such as flubendiamide, chlorantraniliprole, cyantraniliprole, cyclaniliprole, and tetraniliprole; GABA receptor-acting compounds (γ-aminobutyric acid (GABA) antagonists) such as ethiprole, fipronil, pyrafluprole, pyriprole, broflanilide, and fluxametamide; respiratory chain electron transport chain complex I inhibitor compounds such as pyridaben, fenpyroximate, pyrimidifen, tebufenpyrad, and tolfenpyrad; respiratory chain electron transport chain complex II inhibitor compounds such as cyflumetofen, cyenopyrafen, and pyflubumide; respiratory chain electron transport chain complex III inhibitor compounds such as fluacrypyrim, acequinocyl, and flometoquin; ACCase inhibitor compounds such as spirodiclofen, spiromesifen, and spirotetramat; and macrolide compounds such as spinosad, abamectin, milbemycin, spinetoram, lepimectin, and emamectin benzoate, and agrochemically acceptable acid addition salts thereof.

Moreover, other compounds serving as the pesticide include buprofezin, hexythiazox, amitraz, chlordimeform, etoxazole, pymetrozine, bifenazate, flonicamid, chlorfenapyr, pyriproxyfen, indoxacarb, pyridalyl, pyrifluquinazon, metaflumizone, hydramethylnon, triazamate, afidopyropen, renofluthrin, chloroprallethrin, cyhalodiamide, fluazaindolizine, epsilon-metofluthrin, epsilon-momfluorothrin, kappa-bifenthrin, kappa-tefluthrin, fluhexafon, tioxazafen, momfluorothrin, heptafluthrin, pyriminostrobin, cycloxaprid, isocycloseram, oxazosulfyl, tyclopyrazoflor, spiropidion, acynonapyr, dimpropyridaz, indazapyroxamet, flupentiofenox, nicofluprole, cyclobutrifluram, organometallic compounds, dinitro compounds, organosulfur compounds, urea-based compounds, triazine-based compounds, and hydrazine-based compounds, and agrochemically acceptable acid addition salts thereof, and also include microbial pesticides such as BT agents and insect pathogenic virus agents.

of these examples, the pesticide is preferably at least one selected from the group consisting of cartap, thiocyclam, flupyrimin, triflumezopyrim, chlorantraniliprole, cyantraniliprole, tetraniliprole, fipronil, pymetrozine, flonicamid, oxazosulfyl, imidacloprid, and thiamethoxam, and agrochemically acceptable acid addition salts thereof.

More specific examples of the microbicide include strobilurin-based compounds such as azoxystrobin, kresoxim-methyl, trifloxystrobin, metominostrobin, and orysastrobin; anilinopyrimidine-based compounds such as mepanipyrim, pyrimethanil, and cyprodinil; azole-based compounds such as triadimefon, bitertanol, triflumizole, metconazole, propiconazole, penconazole, flusilazole, myclobutanil, cyproconazole, tebuconazole, hexaconazole, prochloraz, and simeconazole; quinoxaline-based compounds such as chinomethionate; dithiocarbamate-based compounds such as maneb, zineb, mancozeb, polycarbamate, and propineb; phenyl carbamate-based compounds such as diethofencarb; organochlorine compounds such as chlorothalonil and quintozene; benzimidazole-based compounds such as benomyl, thiophanate-methyl, and carbendazim; phenylamide-based compounds such as metalaxyl, oxadixyl, ofurace, benalaxyl, furalaxyl, and cyprofuram; sulfenic acid-based compounds such as dichlofluanid; copper-based compounds such as copper hydroxide and oxine-copper; isoxazole-based compounds such as hydroxyisoxazole; organophosphorus compounds such as fosetyl-aluminium and tolclofos-methyl; N-halogenothioalkyl-based compounds such as captan, captafol, and folpet; dicarboximide-based compounds such as procymidone, iprodione, and vinclozolin; carboxanilide-based compounds such as flutolanil, mepronil, furametpyr, thifluzamide, boscalid, and penthiopyrad; morpholine-based compounds such as fenpropimorph and dimethomorph; organotin-based compounds such as fentin hydroxide and fentin acetate; cyanopyrrole-based compounds such as fludioxonil and fenpiclonil; and agrochemically acceptable acid addition salts thereof.

Moreover, other compounds serving as the microbicide include tricyclazole, pyroquilon, carpropamid, diclocymet, fenoxanil, fthalide, fluazinam, cymoxanil, triforine, pyrifenox, fenarimol, fenpropidin, pencycuron, ferimzone, cyazofamid, iprovalicarb, benthiavalicarb-isopropyl, iminoctadin albesilate, cyflufenamid, kasugamycin, validamycin, streptomycin, oxolinic acid, tebufloquin, probenazole, acibenzolar-S-methyl, tiadinil, isotianil, isoprothiolane, tolprocarb, pydiflumetofen, picarbutrazox, mandestrobin, dipymetitrone, pyraziflumid, oxathiapiprolin, penflufen, fluoxapiprolin, flory:picoxamid, fluopimomide, ipflufenoquin, fluindapyr, isoflucypram, quinofumelin, metyltetraprole, pyridachlometyl, pyrapropoyne, aminopyrifen, inpyrfluxam, dichlobentiazox, and agrochemically acceptable acid addition salts thereof.

Of these examples, the microbicide is preferably at least one selected from the group consisting of azoxystrobin, orysastrobin, thifluzamide, furametpyr, fthalide, probenazole, acibenzolar-S-methyl, tiadinil, isotianil, isoprothiolane, tolprocarb, carpropamid, diclocymet, fenoxanil, tricyclazole, pyroquilon, ferimzone, tebufloquin, simeconazole, validamycin, kasugamycin, pencycuron, penflufen, dichlobentiazox, inpyrfluxam, and agrochemically acceptable acid addition salts thereof.

More specific examples of the herbicide include aryloxyphenoxypropionate-based compounds such as cyhalofop-butyl, fenoxaprop-ethyl, fluazifop-butyl, haloxyfop-methyl, metamifop, and quizalofop-ethyl; cyclohexanedione-based compounds such as alloxydim, butroxydim, profoxydim, sethoxydim, and tepralozydim; phenylpyrazoline-based compounds such as pinoxaden; imidazolinone-based compounds such as imazamethabenz-methyl, imazamox, imazapic, imazapyr, imazaquin, and imazethapyr; pyrimidylbenzoate-based compounds such as bispyribac-sodium, pyribenzoxim, pyriftalid, pyriminobac-methyl, and pyrithiobac-sodium; sulfonylurea-based compounds such as pyrimisulfan, triafamone, amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flucetosulfuron, flupyrsulfuron-methyl-Na, foramsulfuron, halosulfuron-methyl, imazosulfuron, iodosulfuron-methyl-Na, mesosulfuron-methyl, metazosulfuron, metsulfuron-methyl, nicosulfuron, orthosulfamuron, oxasulfuron, primisulfuron-methyl, propyrisulfuron, prosulfuron, pyrazosulfuron-ethyl, rimsulfuron, sulfometuron-methyl, sulfosulfuron, thifensulfuron-methyl, and triasulfuron; benzamide-based compounds such as propyzamide, isoxaben, and tebutam; benzoic acid-based compounds such as chlorthal-dimethyl; dinitroaniline-based compounds such as benfluralin, butralin, dinitramine, ethalfluralin, fluchloralin, isopropalin, nitralin, oryzalin, pendimethalin, prodiamine, profluralin, and trifluralin; organophosphorus compounds such as butamifos and DMPA; pyridine-based compounds such as dithiopyr and thiazopyr; benzoate-based compounds such as chloramben, dicamba, and TBA; pyrimidinecarboxylic acid-based compounds such as 2,4,5,-T, 2,4,-D, 2,4-DB, clomeprop, dichlorprop, fenoprop, MCPA, mecoprop, chlorfenprop, aminopyralid, clopyralid, florpyrauxifen, halauxifen, picloram, fluroxypyr, triclopyr, and aminocyclopyrachlor; quinolinecarboxylic acid-based compounds such as quinmerac; acid amide-based compounds such as propanil; phenylcarbamate-based compounds such as chlorprocarb, desmedipham, phenmedipham, and phenmedipham; pyridazinone-based compounds such as chloridazon; triazine-based compounds such as ametryn, atrazine, aziprotryne, cyanazine, desmetryne, dipropetryn, methoprotryne, prometryne, propazine, sebuthylazine, secbumeton, simazine, simetryn, terbumeton, terbuthylazine, terbutryne, trietazine, and procyazine; triazinone-based compounds such as hexazinone, metamitron, and metribuzin; triazolinone-based compounds such as amicarbazone; uracil-based compounds such as bromacil, lenacil, and terbacil; urea-based compounds such as bromuron, chlorbromuron, chlorotoluron, dimefuron, diuron, ethidimuron, fenuron, isouron, methabenzthiazuron, metobromuron, metoxuron, monolinuron, and neburon; benzothiazinone-based compounds such as bentazon; phenylpyridazine-based compounds such as pyridate; glycine-based compounds such as glyphosate; phosphinic acid-based compounds such as bialaphos and glufosinate-ammonium; diphenyl heterocyclic compounds such as fluridone; N-phenyl heterocyclic compounds such as flurochloridone and norflurazon; phenyl ether-based compounds such as beflubutamid, diflufenican, and picolinafen; isoxazolidinone-based compounds such as bixlozone and clomazone; diphenyl ether-based compounds such as acifluorfen, bifenox, chlomethoxyfen, chlornitrofen, fluoroglycofen-ethyl, fomesafen, lactofen, nitrofen, and oxyfluorfen; N-phenylimide-based compounds such as chlorphthalim, cinidon-ethyl, epyrifenacil, flumioxazin, pentoxazone, saflufenacil, tiafenacil, and fluthiacet-methyl; N-phenyloxadiazolone-based compounds such as oxadiargyl and oxadiazon; N-phenyl triazolinone-based compounds such as azafenidin, carfentrazone-ethyl, and sulfentrazone; phenylpyrazole-based compounds such as pyraflufen-ethyl; azolyl carboxamide-based compounds such as cafenstrole, fentrazamide, and ipfencarbazone; benzofuran-based compounds such as benfuresate and ethofumesate; isoxazoline-based compounds such as fenoxasulfone and pyroxasulfone; oxirane-based compounds such as indanofan and tridiphane; thiocarbamate-based compounds such as butylate, cycloate, dimepiperate, EPTC, esprocarb, molinate, orbencarb, pebulate, prosulfocarb, benthiocarb, tiocarbazil, tri-allate, and vernolate; α-chloroacetamide-based compounds such as acetochlor, alachlor, allidochlor, butachlor, butenachlor, delachl.or, dimethachlor, dimethenamid, metazachlor, metolachlor, pethoxamid, pretilachlor, propachlor, propisochlor, prynachlor, and thenylchlor; α-oxyacetamide-based compounds such as thenylchlor, flufenacet, and mefenacet; α-thioacetamide-based compounds such as anilofos and piperophos; arylcarboxylate-based compounds such as diflufenzopyr-sodium and naptalam; pyridinium-based compounds such as cyperquat, diquat, and paraquat; carbamate-based compounds such as barban, carbetamide, chlorbufam, chlorpropham, propham, and swep; dinitrophenol-based compounds such as DNOC, dinosam, dinoseb, dinoterb, etinofen, and medinoterb; isoxazole-based compounds such as isoxaflutole; pyrazole-based compounds such as pyrasulfotole, tolpyralate, topramezone, benzofenap, pyrazolynate, and pyrazoxyfen; triketone-based compounds such as bicyclopyrone, fenquinotrione, mesotrione, sulcotrione, tefuryltrione, tembotrione, and benzobicyclon; arylpyrrolidinone anilide-based compounds such as tetflupyrolimet; alkylazine-based compounds such as indaziflam and triaziflam; nitrile-based compounds such as chlorthiamid, dichlobenil, bromofenoxim, bromoxynil, and ioxynil; triazolocarboxamide-based compounds such as flupoxam; benzyl ether-based compounds such as cinmethylin and methiozolin; diphenyl ether-based compounds such as aclonifen; phenoxypyridazine-based compounds such as cyclopyrimorate; triazole-based compounds such amitrole; quinolinecarboxylate-based compounds such as quinclorac; acetamide-based compounds such as diphenamid, naproanilide, and napropamide; arylaminopropionic acid-based compounds such as flamprop-methyl; chlorocarboxylic acid-based compounds such as dalapon, flupropanate, and TCA; dithiophosphate-based compounds such as bensulide; trifluoromethanesulfonanilide-based compounds such as mefluidide and perfluidone; and agrochemically acceptable acid addition salts thereof.

Moreover, other compounds serving as the herbicide include pyraclonil, endothal, bromobutide, CAMA, cacodylic acid, cumyluron, DSMA, difenzoquat, daimuron, etobenzanid, MSMA, methyldymron, oleic acid, oxaziclomefone, pelargonic acid, pyributicarb, quinoclamine, and agrochemically acceptable acid addition salts thereof.

Of these examples, the herbicide is preferably at least one selected from the group consisting of pretilachlor and agrochemically acceptable salts thereof.

The agrochemical composition of the present invention can exhibit excellent sustained-release properties irrespective of the water solubility of the agrochemical active ingredient contained. For this reason, the agrochemical active ingredient is not particularly limited, and is selected, as appropriate, according to the form, purpose of application, subject of application, and application method of the agrochemical composition, as well as properties of the agrochemical active ingredient, and the like. For example, the agrochemical active ingredient contained in the agrochemical composition of the present invention preferably has a water solubility at 20 to 25° C. of 50 g/L or lower. Note that, as the above-described range of 20° C. to 25° C., the range of 20-0.5° C. to 25+0.5° C. is acceptable. In addition, the water solubility is more preferably 45 g/L or lower, and further preferably 10 g/L. Note that a lower limit of 21. the water solubility may be, for example, 0.1 mg/L.

In the present invention, the “water solubility” refers to the concentration of the agrochemical active ingredient in a saturated aqueous solution, and is measured by a method in OECD GUIDELINE No. 105 (OECD GUIDELINE FOR THE TESTING OF CHEMICALS 105, Adopted 27, 07. 95, https://doi.org/10.1787/97892069589-en). OECD GUIDELINE No. 105 describes two methods: a flask method applied to agrochemical active ingredients having water solubilities higher than 10 mg/L and a column elution method applied to agrochemical active ingredients having water solubilities lower than 10 mg/L, from which the measuring method is selected according to the guideline. In addition, it is also possible to employ, as the “water solubility” in the present invention, one disclosed as the water solubility of each agrochemical active ingredient in the agrochemical abstract (NOYAKU SHOROKU) disclosed in a web site of Japanese Food and Agricultural Materials rnspection Center (FAMIC) (http://www.acis.famic.go.jp/syouroku/index.htm).

Examples of agrochemical active ingredients having such water solubilities include, but are not limited to, flupyrimin, probenazole, thiamethoxam, imidacloprid, tebufloquin and pretilachlor, agrochemically acceptable acid addition salts thereof, and the like.

In the present invention, the agrochemically acceptable acid addition salts include hydrochloric acid salts, nitric acid salts, sulfuric acid salts, phosphoric acid salts, acetic acid salt, and the like, and one of these salts or a combination of two more thereof may be employed.

The amount of the agrochemical active ingredient(s) contained in the agrochemical composition of the present invention (when two or more agrochemical active ingredients are contained, the total amount thereof, hereinafter the same) may be, for example, 0.1 to 60% by mass, 0.2 to 50% by mass, or 0.5 to 40% by mass relative to the total mass of the agrochemical composition, although the amount of the agrochemical active ingredient(s) cannot be generalized, because the amount is subject to adjustment, as appropriate, according to the type, purpose of use, subject of application, and application method of the agrochemical active ingredient(s), and the like.

### (Resin Emulsion)

The “.resin emulsion” in the present invention refers to particles made of a resin and having an average particle diameter of 0.001 to 100 μm. The average particle diameter is preferably 0.005 to 10 μm, and more preferably 0.01 to 5 μm. The average particle diameter of such a resin emulsion is measured, for example, by the laser diffraction scattering particle size distribution measurement method or the dynamic light scattering particle size distribution measurement method. More specifically, the resin emulsion is suspended or diluted in water to a concentration suitable for the measurement, as appropriate, and ultrasonicated with stirring to disperse the particles. The thus prepared measurement sample is measured by using a laser diffraction-type particle size distribution measuring apparatus (for example, LA-960 (HORIBA, Ltd.)) or a dynamic light scattering-type particle size distribution measuring apparatus (for example, DLS-6500 (Otsuka Electronics Co., Ltd,)) to obtain a particle size distribution. The median diameter at which the volume cumulative frequency is 50% in the obtained particle size distribution can be used as the average particle diameter. Presumably, the resin emulsion has an effect of filling voids in the agrochemical composition (especially, granules) to retard the entering of water.

Examples of resins related to the resin emulsion include acrylic resins, vinyl acetate-based resins, urethane-based resins, and the like, and one of these resins or a combination of two more thereof may be employed. In particular, the resin is preferably an acrylic resin.

In the present invention, the “acrylic resin” refers to a polymeric compound whose monomer(s) includes at least an acrylic acid alkyl ester and/or a methacrylic acid alkyl ester (a polymer: a homopolymer or copolymer of the above-described monomers, a copolymer of one or more of the above-described monomers with other monomers). The acrylic acid alkyl ester may be methyl acrylate, ethyl acrylate, butyl acrylate, 2-ethylhexyl acrylate, or the like, and may be one of these acrylates or a combination of two more thereof. Meanwhile, the methacrylic acid alkyl ester may be methyl methacrylate, ethyl methacrylate, or the like, and may be one of these methacrylates or a combination of two more thereof.

The acrylic resin also encompasses polymeric compounds (copolymers) which are, for example, polymerization products of an acrylic acid alkyl ester and/or a methacrylic acid alkyl ester (main monomers) with at least one monomer selected from the group consisting of aromatic vinyl monomers, olefin monomers, silicone macromer, and vinyl versatate. The aromatic vinyl monomers include styrene and the like. The olefin monomers include ethylene, propylene, butadiene, and the like, and one of these olefin monomers or a combination of two more thereof may be employed.

The acrylic resin(s) contained in the agrochemical composition of the present invention may be one of the above-described acrylic resins or a combination of two or more.

More specific examples of the acrylic resin include copolymers of an acrylic acid alkyl ester and a methacrylic acid alkyl ester (for example, Mowinyl-Powder LDM7000P manufactured by Japan Coating Resin co, ltd. and the like), copolymers of an acrylic acid alkyl ester and styrene (for example, Mowinyl 6485, Mowinyl-Powder LDM7400P manufactured by Japan Coating Resin co., ltd. and the like), copolymers of an acrylic acid alkyl ester and a silicone macromer (for example, Mowinyl 7110 manufactured by Japan Coating Resin co., ltd. and the like), copolymers of a methacrylic acid alkyl ester and ethylene (for example, Nucrel N1108C manufactured by DOW-MITSUI POEYCHEMICALS CO., LTD. and the like), and the like.

In the present invention, the “vinyl acetate-based resin” refers to a polymeric compound whose monomer(s) includes at least vinyl acetate (polymer: a homopolymer of the above-described monomers, a copolymer of above-described monomers with other monomers).

The vinyl acetate-based resin also encompasses polymeric compounds (copolymers) which are, for example, polymerization products of vinyl acetate (main monomers) with at least one monomer selected from the group consisting of acrylic acid alkyl esters, methacrylic acid alkyl esters, vinyl versatate, olefin monomers, halogenated olefin monomers, and unsaturated dicarboxylic acids. The acrylic acid alkyl esters include methyl acrylate, ethyl acrylate, butyl acrylate, 2-ethylhexyl acrylate, and the like, and one of these acrylic acid alkyl esters or a combination of two more thereof may be employed. The methacrylic acid alkyl esters include methyl methacrylate and the like, and one of these methacrylic acid alkyl esters or a combination of two more thereof may be employed. In addition, the olefin monomers include ethylene, propylene, butadiene, and the like, and one of these olefin monomers or a combination of two more thereof may be employed. The halogenated olefin monomers include vinyl chloride, vinylidene chloride, and the like, and one of these olefin monomers or a combination of two more thereof may be employed.

The vinyl acetate-based resin(s) contained in the agrochemical composition of the present invention may be one of the above-described vinyl acetate-based resins or a combination of two or more thereof.

More specific examples of the vinyl acetate-based resins include copolymers of vinyl acetate, vinyl versatate, and an acrylic acid alkyl ester (for example, Mowinyl-Powder LDM2072P manufactured by Japan Coating Resin co., ltd, and the like), copolymers of vinyl acetate and ethylene (for example, Mowinyl 180E manufactured by Japan Coating Resin co., ltd. and the like), copolymers of ethylene, vinyl acetate, and vinyl chloride (for example, Sumikaflex 8OSHO manufactured by Sumika Chemtex Company, Limited and the like), and the like.

In the present invention, the “urethane-based resin” refers to a polymeric compound (polymer) having a urethane bond, and is obtained by reacting a polyisocyanate with a polyol. The polyisocyanate includes aliphatic isocyanates such as hexamethylene diisocyanate and isophorone diisocyanate. Meanwhile, the polyol includes polyether polyols such as polyethylene glycol and polypropylene glycol; polyester polyols such as polyethylene adipate glycol and polybutylene adipate glycol; and polycarbonate polyols such as polybutylene carbonate diol and polyhexamethylene carbonate diol. The urethane-based resin(s) may be one of these reaction products between polyisocyanates and polyols or a combination of two or more thereof.

As the resin emulsion used for producing the agrochemical composition of the present invention, those widely distributed as liquid resin emulsion liquids or powdery resin emulsion powders can be used, as appropriate.

The resin emulsion liquid refers to one in which particles made of the above-described resin are dispersed by emulsification in a dispersion medium such as water. The amount of the resin emulsion contained in the resin emulsion liquid is generally about 15 to 70% by mass.

Examples of the resin emulsion liquid include Mowinyl 6485 manufactured by Japan Coating Resin co., ltd. (a copolymer of an acrylic acid alkyl ester and styrene), Narustar SR-140 manufactured by NIPPON A&L INC. (carboxylated butadiene-styrene-methyl methacrylate copolymer), Sumikaflex 808HQ manufactured by Sumika Chemtex Company, Limited (copolymer of ethylene, vinyl acetate, and vinyl chloride), Superflex 500M manufactured by DAS-ICHI KOGYO SEIYAKU CO., LTD. (a urethane resin in which an aliphatic isocyanate and a polyester polyol are polymerized), POLYSOL AP-3140, AP-3820 manufactured by Showa Denko K. K. (styrene-acrylic copolymer resin), and the like.

The resin emulsion powder is also referred to as a re-emulsifiable resin powder and the like, and is generally a water-re-dispersible fine-power substance obtained by adding a stabilizer or the like to the above-described resin emulsion liquid on an as-needed basis, followed by drying by a method such as spray drying.

Examples of the resin emulsion powder include Mowinyl-Powder DM201P manufactured by Japan Coating Resin co., ltd. (a copolymer of vinyl acetate and vinyl versatate), Mowinyl-Powder DM2072P manufactured by Japan Coating Resin co., ltd. (a copolymer of vinyl acetate, vinyl versatate, and an acrylic acid alkyl ester), Mowinyl-Powder LDM7000P manufactured by Japan Coating Resin co., ltd. (a copolymer of an acrylic acid alkyl ester and a methacrylic acid alkyl ester), Mowinyl-Powder LDM7400P manufactured by Japan Coating Resin co., ltd. (a copolymer of an acrylic acid alkyl ester and styrene), VINNAPAS 2012E (a copolymer of an acrylic acid alkyl ester and styrene) and VINNAPAS 2310E (a copolymer of an acrylic acid alkyl ester, styrene, and vinyl versatate) manufactured by WACKER CHEMICALS, ELOTEX TITAN7000 manufactured by Celanese Corporation (a styrene-acrylic acid ester copolymer), ELOTEX FX7000 manufactured by Celanese Corporation (a styrene-acrylic acid ester copolymer), and the like.

When the agrochemical composition of the present invention contains the resin emulsion(s), the amount of the resin emulsion contained (the amount of particles made of the above-described resin; when two or more resin emulsions are contained, the total amount thereof, hereinafter the same) is preferably 0.5 to 40t by mass, more preferably 1 to 30% by mass, and further preferably 2 to 15% by mass, relative to the total mass of the agrochemical composition. If the amount of the resin emulsion contained exceeds the upper limit, the amount of raw material adhering to the apparatus during the production of the agrochemical composition tends to increase, and it tends to be difficult to adjust the sizes of agrochemical granules to a desired uniform size during the production thereof (poor granulation). Meanwhile, if the amount of the resin emulsion contained is less than the lower limit, there is a tendency that an effect (sustained release effect) of suppressing the release of the agrochemical active ingredient into water cannot be obtained sufficiently.

### (Surface-Treated Kaolin)

In the present invention, the “surface-treated kaolin” refers to kaolin whose surface is treated and modified with a surface treatment agent. In the present invention, the “kaolin” refers to a clay mainly containing kaolinite (Al₂Si₂O₅(OH)₄). In the agrochemical composition of the present invention, the surface-treated kaolin presumably has, owing to chemical modification groups added by the surface treatment agent, an effect of reinforcing the interaction with other components such as a binder and the above-described resin emulsion, and thus improving the effect (sustained release effect) of suppressing the release of the agrochemical active ingredient.

The surface treatment agent may be an organic compound having a reactive group capable of reacting with a functional group on the surface of kaolin and the above-described chemical modification group (or a group capable of forming the above-described chemical modification group). Examples of the reactive group include an amino group, a vinyl group, an epoxy group, a methacrylic group, and a mercapto group. Representative surface treatment agents include silane coupling agents, titanate coupling agents, fatty acids, surfactants, and the like.

More specific examples of the silane coupling agents include organic compounds having an alkoxysilyl group (—SiORₙ, where R represents an alkyl group, n represents an integer of 1 to 3, and when n=1 or 2, the other group(s) bound to the silicon atom (Si) is (are) not particularly limited), and examples thereof include mercaptosilanes, aminosilanes, vinylsilanes, and epoxysilanes. The silane coupling agent adds a silanol group (—SiOH) onto the surface of kaolin as the above-described chemical modification group.

The mercapto silanes include 3-mercaptopropyltrimethoxysilane, 3-mercaptopropyltriethoxysilane, and the like. The aminosilanes include N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, N-(vinylbenzyl)-2-aminoethyl-3-aminopropyltrimethoxysilane, hydrochloric acid salts thereof, and the like. The vinylsilanes include vinyltrimethoxysilane, vinyltriethoxysilane, and the like. The epoxysilanes include 2-(3,4-epoxycyclohexyl)ethyltrimethoxysilane, 3-glycidoxypropylmethyldimethoxysilane, 3-glycidoxypropyltrimethoxysilane, 3-glycidoxypropylmethylmethyldiethoxysilane, 3-glycidoxypropyltriethoxysilane, and the like.

More specific examples of the titanate coupling agents include isopropyl triisostearoyl titanate. In addition, more specific examples of the fatty acids include stearic acid, oleic acid, and the like.

Examples of the surface-treated kaolin include calcined kaolin surface-treated with a vinylsilane (for example, Translink 37 and Translink 77 manufactured by BASF; Polyfil WC manufactured by KaMin LLC; Polarite 103A and Polarite 503S manufactured by Imerys Minerals Japan, and the like), calcined kaolin surface-treated with an aminosilane (for example, Translink 445 and Translink 555 manufactured by BASF; Nulok 390 manufactured by KaMin LLC; Amlok 321 manufactured by Kentucky-Tennessee Clay Company; Polarite 102A, Polarite 402A, and Polarite 502A manufactured by Imerys Minerals Japan, and the like), kaolin surface-treated with stearic acid (ASP 101 manufactured by BASF; Nucap 390 and Nucote 7009 manufactured by KaMin. LLC, and the like), calcined kaolin surface-treated with a mercapto silane (Nucap 100G, Nucap 190W, and Nucap 290W manufactured by KaMin LLC; Mercap 100 and Mercap 200 manufactured by Kentucky-Tennessee Clay Company, and the like), and one of these examples or a combination of two more thereof may be employed.

Among these, the surface-treated kaolin according to the present invention is preferably a kaolin surface-treated with a silane whose surface is silane-treated with the above-described silane coupling agent. In the present invention, the “kaolin surface-treated with a silane” refers to kaolin having a surface to which the above-described silanol group is added. In the kaolin surface-treated with a silane, the amount of the silane coupling agent contained is preferably 0.01 to 40% by mass, and more preferably 0.05 to 20% by mass, relative to the total mass of the kaolin surface-treated with a silane. The amount of the silane coupling agent contained can be measured, for example, by a thermogravimetric analysis method in which the change observed during heating of the kaolin surface-treated with a silane is measured, an elemental analysis method, a nondispersive infrared analysis method, or the like.

In addition, the surface-treated kaolin according to the present invention is preferably in the form of particulate surface-treated kaolin particles. The surface-treated kaolin particles have an average particle diameter of preferably 0.01 to 50 μm, and more preferably 0.05 to 10 μm. The average particle diameter of the surface-treated kaolin particles is measured, for example, by a laser diffraction scattering-type particle size distribution measurement method or a dynamic light scattering-type particle size distribution measurement method. More specifically, the surface-treated kaolin particles are suspended, as appropriate, in an about 1% aqueous surfactant (for example, sodium hexametaphosphate) solution at a concentration suitable for the measurement, and ultrasonicated with stirring to disperse the particles. The thus prepared measurement sample is measured for a particle size distribution by using a laser diffraction-type particle size distribution measuring apparatus (for example, LA-960 (HORIBA, Ltd.)) or a dynamic light scattering-type particle size distribution measuring apparatus (for example, DLS-6500 (Otsuka Electronics Co., Ltd.)). The median diameter at which the volume cumulative frequency is 50% in the obtained particle size distribution can be used as the average particle diameter.

When the agrochemical composition of the present invention contains the surface-treated kaolin(s), the amount of the surface-treated kaolin contained (when two or more surface-treated kaolins are contained, the total amount thereof, hereinafter the same) is preferably 0.1 to 60% by mass, more preferably 1 to 50% by mass, and further preferably 5 to 30% by mass, relative to the total mass of the agrochemical composition. If the amount of the surface-treated kaolin(s) contained exceeds the upper limit, poor kneading or poor granulation tends to occur more easily during the production of the agrochemical composition.

Meanwhile, if the amount of the surface-treated kaolin(s) contained is smaller than the above-described lower limit, there is a tendency that an effect (sustained release effect) of suppressing the release of the agrochemical active ingredient into water cannot be obtained sufficiently.

### (Combination of Organically Modified Bentonite and Oil)

### [Organically Modified Bentonite]

In the present invention, the “organically modified bentonite” refers to an organically modified clay obtained by reacting bentonite, which is a smectite-type clay mainly containing montmorillonite, with an organic cation, mainly, a quaternary ammonium ion derived from a fat nitrile, and is also referred to as “*organic bentonite” or the like. The organically modified bentonite is preferably a bentonite treated with a quaternary ammonium compound, which results from a reaction of the bentonite with a quaternary ammonium ion. In the present invention, presumably, the organically modified bentonite, together with the oil described later, not only imparts excellent sustained-release properties to the agrochemical composition of the present invention, but also functions as an improving agent (preferably, a granulation property-improving agent) to further improve manufacturability.

In the present invention, the bentonite encompasses not only weekly alkaline clay minerals mainly containing montmorillonite, but also smectites such as beidellite, nontronite, saponite, and hectorite. Meanwhile, the quaternary ammonium ion includes alkyltrimethylammonium chlorides, dialkyldimethylammonium chlorides, benzyltrialkylammonium chlorides, benzalkonium chloride, and the like.

Examples of the organically modified bentonite include disteardimonium hectorite, dimethyl.distearylammonium hectorite, dimethyldistearylammonium bentonite, benzyldimethylstearylammonium hectorite, trimethylstearylarmmonium bentonite, benzyldimethylstearylammonium bentonite, and the like, and one of these examples or a combination of two more thereof may be employed.

More specific examples of the organically modified bentonite include KUNIVIS 110 and KUNIVIS 127 (which are manufactured by KUNIMINE INDUSTRIES CO., LTD.); S-BEN, S-BEN NTO, S-BEN NZ, S-BEN N270, and S-BEN W (which are manufactured by HOJUN Co., Ltd.); CLAYTONE 34, CLAYTONE 40, CLAYTONE EM, CLAYTONE ER and CLAYTONE HT (which are manufactured by BYK Japan KK), and the like.

In addition, the organically modified bentonite according to the present invention is preferably in the form of particulate organically modified bentonite particles. The organically modified bentonite particles have an average particle diameter of preferably 0.001 to 100 μm, more preferably 0.005 to 60 μm, and further preferably 0.01 to 30 μm. The average particle diameter of the organically modified bentonite particles is measured by, for example, a laser diffraction scattering-type particle size distribution measurement method or a dynamic light scattering-type particle size distribution measurement method. More specifically, the organically modified bentonite particles are suspended, as appropriate, in an about 0.5% aqueous surfactant. (for example, sodium hexametaphosphate and sodium dodecylbenzenesulfonate) solution at a concentration suitable for the measurement, and ultrasonicated with stirring to disperse the particles. The thus prepared measurement sample is measured for a particle size distribution by using a laser diffraction-type particle size distribution measuring apparatus (for example, LA-960 (HORIBA, Ltd.)) or a dynamic light scattering-type particle size distribution measuring apparatus (for example, DLS-6500 (Otsuka Electronics Co., Ltd.)). The median diameter at which the volume cumulative frequency is 50% in the obtained particle size distribution can be used as the average particle diameter.

When the agrochemical composition of the present invention contains the organically modified bentonite(s), the amount of the organically modified bentonite contained (when two or more organically modified bentonites are contained, the total amount thereof, hereinafter the same) is preferably 0.05 to 40% by mass, more preferably 0.1 to 30% by mass, and further preferably 0.2 to 20% by mass, relative to the total mass of the agrochemical composition. If the amount of the organically modified bentonite(s) contained exceeds the upper limit, poor kneading or poor granulation tends to occur more easily during the production of the agrochemical composition. Meanwhile, if the amount of the organically modified bentonite(s) contained is smaller than the lower limit, there is a tendency that an effect (sustained release effect) of suppressing the release of the agrochemical active ingredient into water cannot be obtained sufficiently.

### [Oil]

In the present invention, the “oil” encompasses not only ester compounds of fatty acids and glycerin (fats and fatty oils), but also hydrocarbon-based oils. In the present invention, presumably, the oil, together with the above-described organically modified bentonite, not only imparts excellent sustained-release properties to the agrochemical composition of the present invention, but also functions as an improving agent (preferably a granulation property-improving agent) to further improve manufacturability.

Examples of the fats and fatty oils include vegetable oils which are liquid at ordinary temperature, such as salad oils, refined rapeseed oil, corn oil, soybean oil, sesame oil, rapeseed oil (canola oil), rice oil (rice bran oil), palm kernel oil, cottonseed oil, castor oil, and the like; animal fats and fatty oils which are liquid at ordinary temperature, such as fish oils and cod liver oil; vegetable oils which are solid at ordinary temperature, such as cocoa butter, peanut butter, palm oil, and coconut oil; animal fats and fatty oils which are solid at ordinary temperature, such as lard, beef tallow, and butterfat (butter, ghee).

Examples of the hydrocarbon-based oils include 0.1.0 essential oils mainly containing terpenoids or the like; aliphatic hydrocarbons such as normal paraffin, isoparaffin, and liquid paraffin; and aromatic hydrocarbons such as alkylbenzenes and alkylnaphthalenes. In addition, examples of the hydrocarbon-based oils also include synthetic oils (hydrocarbon-based esters) such as fatty acid methyl esters and dibasic acid methyl esters.

The oil according to the present invention may be one of these examples or a combination of two or more thereof. However, from the viewpoints of ease of operation and safety, the oil is preferably liquid at ordinary temperature (a high-boiling point oil), more preferably at least one selected from the group consisting of vegetable oils (preferably liquid at ordinary temperature) such as rapeseed oil, refined rapeseed oil, and cottonseed oil and hydrocarbon-based oils, and further preferably at least one selected from the group consisting of hydrocarbon-based oils such as aliphatic hydrocarbons (for example, liquid paraffin). Here, the above-described ordinary temperature more specifically refers to “15° C. to 25° C.,” which is ordinary temperature as specified in General Notices of The Japanese Pharmacopoeia, the 18th Edition. In addition, from the viewpoint of handling during operation, properties of the liquid are, for example, such that the viscosity at 25° C. as measured by using a type-B viscometer (manufactured by TOKIMEC, VISCOMETER MODEL BM) under the following conditions: rotors used: 3 or 4, number of revolutions: 60 r/min, measurement time; 60 seconds is preferably 1000 mPa·s or lower, more preferably 800 mPa·s or lower, and further preferably 500 mPa·s or lower.

When the agrochemical composition of the present invention contains the above-described oil(s), the amount of the oil contained (when two or more oils are contained, the total amount thereof, hereinafter the same) is preferably 0.05 to 40% by mass, more preferably 0.1 to 30% by mass, and further preferably 0.5 to 201 by mass, relative to the total mass of the agrochemical composition. If the amount of the oil(s) contained exceeds the upper limit, the amount of raw material adhering to the apparatus during the production of the agrochemical composition tends to increase, and it tends to be difficult to adjust the sizes of agrochemical granules to a desired uniform size during the production thereof (poor granulation). Meanwhile, if the amount of the oil(s) contained is smaller than the lower limit, there is a tendency that an effect (sustained release effect) of suppressing the release of the agrochemical active ingredient into water cannot be obtained sufficiently.

In addition, in the agrochemical composition of the present invention, when the oil is contained, the organically modified bentonite is also contained, whereas when the organically modified bentonite is contained, the oil is also contained. However, this does not exclude agrochemical compositions that comprise only one of the oil and the organically modified bentonite in addition to the resin emulsion and the surface-treated kaolin. Presumably, when contained in combination in the agrochemical composition, these components not only impart excellent sustained-release properties to the agrochemical composition of the present invention, but also function as an improving agent (preferably a granulation property-improving agent) to further improve manufacturability.

When the agrochemical composition of the present invention contains a combination of an organically modified bentonite and an oil, the amount thereof contained (the total amount of the amount of the organically modified bentonite(s) contained and the amount of the oil (s) contained, hereinafter the same) is preferably 0.1 to 50% by mass, more preferably 0.2 to 40% by mass, and further preferably 0.7 to 30% by mass, relative to the total mass of the agrochemical composition. If the total amount contained exceeds the upper limit, the amount of raw material adhering to the apparatus during the production of the agrochemical composition tends to increase, and it tends to be difficult to adjust the sizes of agrochemical granules to a desired uniform size during the production thereof (poor granulation). Meanwhile, if the total amount contained is smaller than the lower limit, there is a tendency that an effect of suppressing the release of the agrochemical active ingredient into water cannot be obtained sufficiently.

Here, the mass ratio between the amount of the organically modified bentonite(s) contained and the amount of the oil(s) contained (the amount of the organically modified bentonite(s) contained:the amount of the oil(s) contained) in the agrochemical composition of the present invention is preferably 1:30 to 30:1, more preferably 1:20 to 20:1, further preferably 1:10 to 10:1, and further more preferably 1:5 to 5:1, from the same viewpoints as described above.

The agrochemical composition of the present invention only needs to contain two or more selected from the group consisting of the following three: the resin emulsion, the surface-treated kaolin, and the combination of the organically modified bentonite and the oil, and examples are the following combinations.

### (Combination of Resin Emulsion and Surface-Treated Kaolin)

In this case, the total amount of the amount of the resin emulsion(s) contained and the amount of the surface-treated kaolin(s) contained is preferably 0.6 to 70% by mass, more preferably 2 to 60% by mass, and further preferably 7 to 50% by mass, relative to the total mass of the agrochemical composition. If the total amount exceeds the upper limit, the amount of raw material adhering to the apparatus during the production of the agrochemical composition tends to increase, and it tends to be difficult to adjust the sizes of agrochemical granules to a desired uniform size during the production thereof (poor granulation). Meanwhile, if the total amount is smaller than the lower limit, there is a tendency that an effect (sustained release effect) of suppressing the release of the agrochemical active ingredient into water cannot be obtained sufficiently.

(Combination of Resin Emulsion, Organically modified Bentonite, and Oil)

In this case, the total amount of the amount of the resin emulsion(s) contained and the amount of the organically modified bentonite(s) and the oil(s) contained is preferably 0.6 to 50% by mass, more preferably 1.2 to 40% by mass, and further preferably 2.7 to 30% by mass, relative to the total mass of the agrochemical composition. If the total amount exceeds the upper limit, the amount of raw material adhering to the apparatus during the production of the agrochemical composition tends to increase, and it tends to be difficult to adjust the sizes of agrochemical granules to a desired uniform size during the production thereof (poor granulation). Meanwhile, if the total amount is smaller than the lower limit, there is a tendency that an effect (sustained release effect) of suppressing the release of the agrochemical active ingredient into water cannot be obtained sufficiently.

(Combination of Surface-Treated Kaolin, Organically Modified Bentonite, and oil)

In this case, the total amount of the amount of the surface-treated kaolin(s) contained and the amount of the organically modified bentonite(s) and the oil(s) contained is preferably 0.2 to 60% by mass, more preferably 1.2 to 50% by mass, and further preferably 5.7 to 40% by mass, relative to the total mass of the agrochemical composition. If the amount exceeds the upper limit, the amount of raw material adhering to the apparatus during the production of the agrochemical composition tends to increase, and it tends to be difficult to adjust the sizes of agrochemical granules to a desired uniform size during the production thereof (poor granulation). Meanwhile, if the amount is smaller than the lower limit, there is a tendency that an effect (sustained release effect) of suppressing the release of the agrochemical active ingredient into water cannot be obtained sufficiently.

### (Combination of Resin Emulsion, Surface-Treated Kaolin, Organically Modified Bentonite, and Oil)

In this case, the total amount of the amount of the resin emulsion(s) contained, the amount of the surface-treated kaolin(s) contained, and the amount of the organically modified bentonite(s) and the oil(s) contained is preferably 0.7 to 70% by mass, more preferably 2.2 to 60% by mass, and further preferably 7.7 to 50% by mass, relative to the total mass of the agrochemical composition. If the total amount exceeds the upper limit, the amount of raw material adhering to the apparatus during the production of the agrochemical composition tends to increase, and it tends to be difficult to adjust the sizes of agrochemical granules to a desired uniform size during the production thereof (poor granulation). Meanwhile, if the total amount is smaller than the lower limit, there is a tendency that an effect (sustained release effect) of suppressing the release of the agrochemical active ingredient into water cannot be obtained sufficiently.

### (Auxiliary Agent)

In addition to the above-described agrochemical active ingredient and the above-described three components (the resin emulsion, the surface-treated kaolin, and the combination of the organically modified bentonite and the oil), the agrochemical composition of the present invention may further comprise auxiliary agents such as surfactants, binders, fillers, antifungal agents, coloring agents, and stabilizers, within a range not impairing an effect of the present invention.

When the agrochemical composition of the present invention contains the auxiliary agent(s), one auxiliary agent or a combination of two or more auxiliary agents may be contained. The amount of the auxiliary agent contained (when two or more auxiliary agents are contained, the total amount thereof) can be adjusted, as appropriate, according to the type or combination thereof, and may be, for example, 0.01 to 80% by mass, and is preferably 1 to 80% by mass, and more preferably 5 to 70t by mass, relative to the total mass of the agrochemical composition.

### (Surfactant)

Examples of the surfactants include anionic surfactants, nonionic surfactants, cationic surfactants, and amphoteric surfactants, and one of these surfactants or a combination of two more thereof may be employed.

Examples of the anionic surfactants include polyoxyethylene alkyl ether sulfates, polyoxyalkylene alkylphenyl ether sulfates, polyoxyalkylene styrylphenyl ether sulfates, polyoxyethylene polyoxypropylene block polymer sulfates, alkyl sulfates, alkane sulfonates, α-olefin sulfonic acid salts, dialkyl sulfosuccinates, alkylbenzenesulfonates, alkylsulfonates, alkyl diphenyl ether disulfonates, ligninsulfonates, alkylnaphthalenesulfonates, formalin condensate salts of (alkyl)naphthalenesulfonic acids, polyoxyalkylene alkylphenyl ether sulfonates, fatty acid salts, N-methyl-fatty acid sarcosinate, resin acid salts, polyoxyethylene alkyl ether phosphates, polyoxyalkylene alkylphenyl ether phosphates, polycarboxylic acid-type surfactants, and the like. Note that each of the above-described polyoxyalkylenes is not particularly limited, unless an effect of the present invention is impaired, and the polyoxyalkylene is preferably one or a mixture selected from the group consisting of polyoxyethylene and polyoxypropylene.

Examples of the nonionic surfactants include sorbitan fatty acid esters, polyoxyalkylene sorbitan fatty acid esters, sucrose fatty acid esters, polyoxyalkylene fatty acid esters, polyoxyalkylene resin acid esters, polyoxyalkylene castor oil, polyoxyalkylene hydrogenated castor oil, polyoxyethylene alkyl ethers, polyoxyalkylene alkylphenyl ethers, polyoxyethylene polyoxypropylene block polymers, polyoxyethylene polyoxypropylene alkyl ethers, polyoxyalkylene alkylamines, polyoxyalkylene fatty acid amides, polyoxyalkylene styrylphenyl ethers, silicone-based surfactants, acetylene glycol-based surfactants, and the like. Note that each of the above-described polyoxyalkylenes is not particularly limited, unless an effect of the present invention is impaired, and the polyoxyalkylene is preferably one or a mixture selected from the group consisting of polyoxyethylene and polyoxypropylene.

The cationic surfactants include alkyltrimethylammonium chlorides, alkyldimethylbenzalkonium chlorides, alkylamines, and the like. Meanwhile, the amphoteric surfactants include dialkylaminoethyl betaines, alkyl dimethyl benzyl betaines, and the like.

When the agrochemical composition of the present invention contains the surfactant(s), the amount of the surfactant contained (when two or more surfactants are contained, the total amount thereof) is preferably 0.01 to 20% by mass, and more preferably 0.1 to 10% by mass, relative to the total mass of the agrochemical composition.

### [Binder]

Examples of the binders include, but are not limited to, lignosulfonic acid salts; cellulose derivatives such as carboxymethyl cellulose sodium, methyl cellulose, and hydroxypropyl methyl cellulose; modified starches such as starch and dextrin; saccharides such as glucose and sucrose; polyacrylates such as sodium polyacrylate (excluding the above-described acrylic resin emulsions); polyvinyl derivatives such as polyvinyl alcohol and polyvinylpyrrolidone (excluding the above-described vinyl acetate-based resin emulsions); natural product-derived gums such as sodium alginate, gum arabic, gelatin, locust bean gum, xanthan gum, and casein, and one of these binders or a combination of two more thereof may be employed.

When the agrochemical composition of the present invention contains the binder(s), the amount of the binder contained (when two or more binders are contained, the total amount thereof) is preferably 0.05 to 20% by mass, and more preferably 0.1 to 10% by mass, relative to the total mass of the agrochemical composition.

[Filler]

The above-described fillers include, but are not limited to, naturally occurring minerals and calcined products thereof such as clay, talc, bentonite (excluding the above-described organically modified bentonite), kaolin (calcined kaolin, hydrous kaolin, and the like; excluding the above-described surface-treated kaolin), zeolite, acid clay, diatomaceous earth, vermiculite, perlite, and pumice; inorganic salts such as calcium carbonate, potassium chloride, ammonium sulfate, and sodium sulfate; plant-derived substances such as wood flour and corncob; urea, white carbon, titanium dioxide, and the like, and one of these fillers or a combination of two more thereof may be employed.

When the agrochemical composition of the present invention contains the above-described filler(s), the amount of the filler contained (when two or more fillers are contained, the total amount thereof) is preferably 2 to 80% by mass, and more preferably 5 to 70% by mass, relative to the total mass of the agrochemical composition.

### [Antifungal Agent, Coloring Agent, and Stabilizer]

Examples of the antifungal agents include, but are not limited to, sodium benzoate, potassium sorbate, para-hydroxybenzoic acid esters, 1,2-benzisothiazolin-3-one, and the like. One of these antifungal agents or a combination of two more thereof may be employed.

Examples of the coloring agents include, but are not limited to, coal tar dyes such as Blue No. 1 and Red No. 2; caramel color, and the like. One of these coloring agents or a combination of two more thereof may be employed.

Examples of the stabilizers include, but are not limited to, antioxidants, anti-ultraviolet ray agents, desiccants, and the like. One of these stabilizers or a combination of two more thereof may be employed.

### (Agrochemical Granules)

Forms of the agrochemical composition of the present invention include dust formulations (including driftless dusts (DL dusts) and flow dusts (FDs)), dust-granule mixtures, granules, wettable powders (including flowables and water-dispersible granules), water-solubles (including water-soluble granules), emulsifiable concentrates (including emulsions and suspoemulsions), liquid formulations, oil solutions, aerosols, fumigants, microcapsules, and the like. From the viewpoint of achieving excellent sustained-release properties, the agrochemical composition of the present invention is preferably in the form of granules (also referred to as “agrochemical granules” in some cases in the present specification).

The granules generally refer to those having maximum particle diameters of 0.03 to 100 mm (the maximum particle diameters are preferably 0.06 to 10 mm, 0.1 to 2.0 mm, or 0.3 to 1.7 mm in the present invention), and the granules also encompass tablets and particles in the present invention. Shapes of the granules are not particularly limited, and include cylindrical, pellet-like, and tablet-like shapes, and the like. The granules may be in a packed form in which the granules are packaged in water-soluble films or the like. Note that the maximum particle diameter refers to the diameter of a circle obtained by projecting the granule onto a plane, and if the projection is not circular (if the shape of the particle is a flat-plate shape, a plate shape, or the like, or a rod-like shape, a polygonal shape, or the like), the maximum particle diameter refers to the diameter of the circumscribed circle of the projection.

### (Sustained-Release)

The present invention provides an agrochemical composition capable of sufficiently suppressing the rapid release of the agrochemical active ingredient into water at an initial stage, i.e., a sustained-release agrochemical composition. In the present invention, the “sustained-release” means that when an agrochemical composition (preferably the above-described granules) is placed into water, the amount of the agrochemical active ingredient released into water per hour is small. The “sustained-release” can be evaluated by, for example, the amount (the amount released) or the concentration (released concentration) of the agrochemical active ingredient determined by adding 500 mg of the agrochemical composition into a test container containing 100 mL of deionized water at 40° C., and, 3 hours later, measuring the solution in the test container by high performance liquid chromatography.

### (Application Method)

Without any particular limitation, the agrochemical composition of the present invention can be applied to a subject, as appropriate, according to the type of the agrochemical active ingredient contained, such that an effective amount (adjusted according to the type of the agrochemical active ingredient, purpose of application, application method of the agrochemical composition, and the like) of the agrochemical active ingredient can be applied. For example, the agrochemical composition of the present invention (preferably granules) can be sprayed directly and uniformly into paddy water or to agricultural fields or culture media (culture media for hydroponics, sandculture, NFT (nutrient film technique), rock wool culture, and the like; solid culture media such as artificial culture soils and artificial mats for cultivating seedlings, and the like) for cultivating crop plants. In addition, the agrochemical composition of the present invention (preferably granules) can also be used as a planting-hole treatment agent or a box 1.0 treatment agent.

The agrochemical composition of the present invention is excellent in sustained-release properties and can sufficiently suppress agrochemical-induced adverse effect on crop plants. Accordingly, examples of crop plants to which the agrochemical composition of the present invention can be applied include, but are not particularly limited to, useful plants such as cereals, bean plants, grasses for sugar production, vegetables, fruit trees, and the like. For example, from the viewpoint of particularly requiring suppression of rapid release of the agrochemical active ingredient into water, the crop plants may be those of the family Poaceae including paddy-field rice.

### <Method for Producing Agrochemical Composition>

Methods for producing the agrochemical composition of the present invention are not particularly limited, and the agrochemical composition of the present invention can be obtained, for example, by mixing two or more selected from the group consisting of the following three: the above-described resin emulsion, the above-described surface-treated kaolin, and the combination of the above-described organically modified bentonite and the above-described oil, the above-described agrochemical active ingredient, and, if necessary, the above-described auxiliary agent and/or solvent (for example, water) together, and by employing a conventional method known as a method for producing an agrochemical preparation or a similar method.

In particular, when the agrochemical composition of the present invention is in the form of granules (agrochemical granules), the method for producing the agrochemical granules preferably comprises a step of mixing and granulating two or more selected from the group consisting of the following three: the above-described resin emulsion, the above-described surface-treated kaolin, the combination of the above-described organically modified bentonite and the above-described oil, the above-described agrochemical active ingredient, and, if necessary, the above-described auxiliary agent and/or solvent (for example, water).

Methods for the mixing and granulation are not particularly limited, and a conventional method known as a method for producing an agrochemical preparation or a similar method can be employed, as appropriate. Examples thereof include the extruding granulation method, the tumbling granulation method, the tumbling fluidized-bed granulation method, the fluidized-bed granulation method, the agitation and mixing granulation method, the compression granulation method, and the tableting method. For example, when cylindrical granules are produced, the extruding granulation method is preferable, whereas when spherical granules are produced, the tumbling granulation method or the agitation and mixing granulation method is preferable.

In the case of the extruding granulation method, for example, first, two or more selected from the group consisting of the following three: the above-described resin emulsion, the above-described surface-treated kaolin, the combination of the above-described organically modified bentonite and the above-described oil, the above-described agrochemical active ingredient, and, if necessary, the above-described auxiliary agent are uniformly mixed by using a high-speed agitation and mixing apparatus, a ribbon mixer, or the like to obtain a mixture. The above-described components used each may be subjected to pulverization treatment in advance, if necessary. In addition, when the resin emulsion is used, either the above-described resin emulsion liquids or the above-described resin emulsion powders may be used, and from the viewpoint of better manufacturability, the resin emulsion powders are preferably used.

Subsequently, a solvent such as water is added to the obtained mixture, which is then further mixed (kneaded) by using a double-arm kneader or a ribbon mixer to obtain a kneaded material. Subsequently, the obtained kneaded material is granulated by using an extrusion granulator such as a basket-type granulator or a screw-type granulator. The extrusion hole diameter (screen diameter) for the granulation is not particularly limited, and is generally in the range of, for example, 0.03 to 100 mm (preferably, 0.3 to 10 mm, more preferably, 0.5 to 5 mm). According to the production method of the present invention, a high yield can be achieved without being greatly restricted by the amount of the solvent, and hence the agrochemical granules of the present invention can be obtained easily and highly efficiently.

Subsequently, the obtained granulated material is, if necessary, spheronized in a marumerizer or the like, then dried by using a fluidized-bed dryer, a bed-type dryer, or the like to remove the solvent, and, if necessary, subjected to sieving or the like. Thus, agrochemical granules of the present invention can be obtained.

In addition, the method for producing the agrochemical granules of the present invention may be a method in which two or more selected from the group consisting of the following three: the above-described resin emulsion, the above-described surface-treated kaolin, the combination of the above-described organically modified bentonite and the above-described oil, and, if necessary, the above-described auxiliary agent and/or solvent (for example, water) are mixed and granulated, and then the agrochemical active ingredient is introduced into the obtained granulated material.

The method for obtaining the granulated material (granulation step) is the same as described above, except that the agrochemical active ingredient is not used. In addition, the method for introducing the agrochemical active ingredient into the granulated material may be, for example, a method in which the granulated material is impregnated with the agrochemical active ingredient (for example, a solution of the agrochemical active ingredient (preferably an organic solvent solution)), a method in which the agrochemical active ingredient is sprayed with a sprayer or the like and, if necessary, then the solvent of the agrochemical active ingredient is removed by drying, or the like.

### EXAMPLES

Hereinafter, the present invention is described specifically based on Examples and Comparative Examples; however, the present invention is not limited to Examples below. Note that, in each of Examples and Comparative Examples, the water solubility of flupyrimin is that measured at 20° C. according to the method described in OECD GUIDELINE No. 105 (OECD GUIDELINE FOR THE TESTING OF CHEMICALS 105, Adopted 27. 07. 95, https://doi.org/10.1787/978926069589-en), and the water solubilities of the other agrochemical active ingredients are those disclosed as the water solubilities of these agrochemical active ingredients in the agrochemical abstract (NOYAKU SHOROKU) on the web site of Japanese Food and Agricultural Materials Inspection Center (FAMIC) (http://www.acis.famic.go.jp/syouroku/index.htm).

### Example 1

First, a mixture was obtained by mixing 10.25 parts by mass of probenazole (water solubility (20° C.): 36.6 mg/L, purity: 97.6%, manufactured by Meiji Seika Pharma Co., Ltd.) (probenazole: 10.004 parts by mass), 2.00 parts by mass of flupyrimin (water solubility (20° C.): 167 mg/L, purity: 100.0%, manufactured by Meiji Seika Pharma Co., Ltd.), 20.00 parts by mass of a surface-treated kaolin (calcined kaolin surface-treated with a mercapto silane, Nucap 290W, manufactured by KaMin LLC), 3.00 parts by mass of an organically modified bentonite (bentonite surface-treated with a quaternary ammonium compound, KUNIVIS 127, manufactured by KUNIMINE INDUSTRIES CO., LTD.), 5.00 parts by mass of an oil (hydrocarbon-based oil, liquid paraffin No. 260S, manufactured by Sanko Chemical Industry Co., Ltd.), 0.30 parts by mass of a surfactant (sodium lauryl sulfate (alkyl sulfate): EMAL 10PT, manufactured by Kao Corporation), 2.00 parts by mass of a binder (polyvinyl alcohol: KURARAY POVAL 44-88S, manufactured by KURARAY CO., LTD.), and 57.45 parts by mass of a filler (clay, Showa Clay 704N, manufactured by Showa. KDE Co., Ltd.) in a mixing apparatus (fiber mixer, manufactured by Panasonic Corporation). To the obtained mixture, a suitable amount of water was added, followed by kneading in a vertical kneader (Model; ACMO8LVT-B, manufactured by AICOHSHA MFG.. CO., LTD.). The obtained kneaded material was granulated by using Multi-Gran (Model: MG-55, manufactured by DALTON CORPORATION) equipped with a screen having a diameter of 1.0 mm, and dried at 60° C. for 2 hours to remove water, thereby obtaining an agrochemical composition (granules). Table 1 below shows the makeup of the obtained agrochemical composition.

### Examples 2 to 5 and Comparative Examples 1 to 6

Agrochemical compositions (granules) were each obtained in the same manner as in Example 1, except that the makeup of the agrochemical composition was changed as shown in Table 1 or Table 2 below. In Table 1, the resin emulsion used was Mowinyl LDM7400P manufactured by Japan Coating Resin co., ltd. (acrylic resin emulsion (powder), Mowinyl-Powder LDM7400P). In Table 2, the calcined kaolin used was kaolin 70C manufactured by KaMin LLC, the organically modified bentonite used was KUNIVIS 110 (bentonite surface-treated with a quaternary ammonium compound) manufactured by KUNIMINE INDUSTRIES CO., LTD., and the bentonite used was KUNIGEL V1 manufactured by KUNIMINE INDUSTRIES CO., LTD.

TABLE 1

| | | | | | | Comp. | Comp. |
|---|---|---|---|---|---|---|---|
| | Ex. 1 | Ex. 2 | Ex. 3. | Ex. 4 | Ex. 5 | Ex. 1 | Ex. 2 |
| Probenazole (purity: 97.6%) | 10.25 | 10.25 | 10.25 | 10.25 | 24.59 | 10.25 | 24.59 |
| Flupyrimin | 2.00 | 2.00 | 2.00 | 2.00 | 2.00 | 2.00 | 2.00 |
| Resin emulsion (Mowinyl LDM7400P, | — | 10.00 | 10.00 | 10.00 | 10.00 | — | — |
| powder) | | | | | | | |
| Surface-treated kaolin (Nucap 290W) | 20.00 | 20.00 | — | 20.00 | 20.00 | — | — |
| Organically modified bentonite | 3.00 | — | 3.00 | 3.00 | 3.00 | — | — |
| (KUNIVIS 127) | | | | | | | |
| Oil (liquid paraffin No. 260S) | 5.00 | — | 5.00 | 5.00 | 5.00 | — | — |
| Surfactant | 0.30 | 0.30 | 0.30 | 0.30 | 0.30 | 0.30 | 0.30 |
| Binder | 2.00 | 0.50 | 0.50 | 0.50 | 0.50 | 2.00 | 2.00 |
| Filler | 57.45 | 56.95 | 68.95 | 48.95 | 34.61 | 85.45 | 71.11 |
| Total amount | 100.0 | 100.0 | 100.0 | 100.0 | 100.0 | 100.0 | 100.0 |

TABLE 2

| | Comp. | Comp. | Comp. | Comp. |
|---|---|---|---|---|
| | Ex. 3 | Ex. 4 | Ex. 5 | Ex. 6 |
| Probenazole (purity: 97.6%) | 10.25 | 10.25 | 10.25 | 10.25 |
| Flupyrimin | 2.00 | 2.00 | 2.00 | 2.00 |
| Calcined kaolin (kaolin 70C) | 20.00 | — | — | — |
| Organically modified | — | — | 3.00 | — |
| bentonite (KUNIVIS 110) | | | | |
| Bentonite (KUNIGEL V1) | — | 3.00 | — | 3.00 |
| Oil (liquid paraffin No. 260S) | — | — | — | 5.00 |
| Surfactant | 0.30 | 0.30 | 0.30 | 0.30 |
| Binder | 2.00 | 2.00 | 2.00 | 2.00 |
| Filler | 65.45 | 82.45 | 82.45 | 77.45 |
| Total amount | 100.0 | 100.0 | 100.0 | 100.0 |

### (Release Test)

First, test containers (capacity: 100 mL) were each charged with 100 m.: of deionized water, and allowed to stand in a thermostatic chamber, to raise the water temperature to 40° C. Subsequently, 500 mg of the agrochemical compositions obtained in Examples and Comparative Examples were introduced into the test containers. Three hours after the introduction, the solution in each test container was gently shaken to make the solution uniform. Then, approximately: mL was taken, and filtered through a membrane filter having a pore diameter of 0.45 μm. The concentrations of the agrochemical active ingredients (probenazole and flupyrimin) in the filtrate were measured by high performance liquid chromatography, and the concentration (released concentration (ppm)) of each of the agrochemical active ingredients in the test container at three hours post-introduction was calculated. Tables 3 and 4 below shows the results.

### (Test for Agrochemical-Induced Adverse Effect)

First, forced germinated seeds (rice) were sown in germinator boxes at 150 g/box, and treatment with each of the agrochemical compositions obtained in Examples and Comparative Examples was conducted uniformly at 50 g/box. Then, the seeds were covered with soil. The seeds were allowed to further germinate in the dark at 30° C. for 2 days, and then cultivated under conditions of 30° C. in the daytime and 12° C. in the nighttime. Thirteen days after the sowing, 20 plants were selected at random from each of the germinator boxes, the lengths of these plants were measured, and the average (cm) was calculated. Tables 3 and 4 below also show the obtained average values (lengths of plants (cm)).

TABLE 3

| | | | | | | Comp. | Comp. |
|---|---|---|---|---|---|---|---|
| | Ex. 1 | Ex. 2 | Ex. 3 | Ex. 4 | Ex. 5 | Ex. 1 | Ex. 2 |
| Concentration of flupyrimin | 13.2 | 10.2 | 13.5 | 10.2 | 10.8 | 20.7 | 21.4 |
| released after 3 hours (ppm) | | | | | | | |
| Concentration of probenazole | 11.0 | 10.6 | 14.7 | 11.3 | 14.2 | 20.7 | 29.1 |
| released after 3 hours (ppm) | | | | | | | |
| Length of plants (cm) | 13.41 | 10.39 | 12.43 | 13.29 | 10.17 | 8.90 | 6.88 |

TABLE 4

| | Comp. | Comp. | Comp. | Comp. |
|---|---|---|---|---|
| | Ex. 3 | Ex. 4 | Ex. 5 | Ex. 6 |
| Concentration of flupyrimin | 21.8 | 15.8 | 17.0 | 15.8 |
| released after 3 hours (ppm) | | | | |
| Concentration of probenazole | 17.4 | 14.7 | 13.2 | 24.7 |
| released after 3 hours (ppm) | | | | |
| Length of plants (cm) | 8.91 | 9.36 | — | 9.54 |

As shown in Tables 3 and 4, it was found from the results of the release test that each of the agrochemical compositions of the present invention (for example, Examples 1 to 5) had sufficiently low released concentrations of the agrochemical active ingredients, and had excellent sustained-release properties, compared to the agrochemical composition comprising none of the resin emulsion, the surface-treated kaolin, the organically modified bentonite, and the oil according to the present invention (for example, Comparative Examples 1 or 2). Moreover, it was found from the results of the test for agrochemical-induced adverse effect that the lengths of the rice plants treated with each of the agrochemical compositions of the present invention (for example, Examples 1 to 5) were sufficiently large, and the agrochemical-induced adverse effect was sufficiently reduced. Meanwhile, it was found that the agrochemical compositions (for example, Comparative Examples 1 to 4) comprising none of the resin emulsion, the surface-treated kaolin, the organically modified bentonite, and the oil according to the present invention and the agrochemical compositions (for example, Comparative Examples 5 and 6) not comprising at least two or more of the resin emulsion, the surface-treated kaolin, and the combination of the organically modified bentonite and the oil according to the present invention were inferior to the agrochemical compositions of the present invention in terms of at least one of the released concentrations and the length of plants.

### Example 6

First, a mixture was obtained by mixing 10.25 parts by mass of probenazole (water solubility (20° C.): 36.6 mg/L, purity: 97.6%, manufactured by Meiji Seika Pharma Co., Ltd.) (probenazole: 10.004 parts by mass), 2.03 parts by mass of flupyrimin (water solubility (20° C.): 167 mg/L, purity: 100.0%, manufactured by Meiji Seika Pharma Co., Ltd.), 10.00 parts by mass of a resin emulsion (acrylic resin emulsion (powder), Mowinyl. LDM7400P (Mowinyl-Powder LDM7400P), manufactured by 13 Japan Coating Resin co., ltd.), 3.00 parts by mass of an organically modified bentonite (bentonite surface-treated with a quaternary ammonium compound, KUNIVIS 127, manufactured by KUNIMINE INDUSTRIES CO., LTD.), 5.00 parts by mass of an oil (hydrocarbon-based oil, liquid paraffin No. 260S, manufactured by Sanko Chemical Industry Co., Ltd.), 0.30 parts by mass of a surfactant (sodium lauryl sulfate (alkyl sulfate): EMAL 10PT, manufactured by Kao Corporation), 0.50 parts by mass of a binder (polyvinyl alcohol: KURARAY POVAL 44-88S, manufactured by KURARAY CO., LTD.), and 68.95 parts by mass of a filler (clay, Showa Clay 70N, manufactured by Showa KDE Co., Ltd.) in a mixing apparatus (fiber mixer, manufactured by Panasonic Corporation). To the obtained mixture, water was added such that the water content (mass of water/(mass of mixture+mass of water)×100(%)) was 9%, followed by kneading in a vertical kneader (Model: ACMOSLVT-B, manufactured by AICOHSHA MFG. CO., LTD.). The obtained kneaded material was granulated by using Multi-Gran (Model: MG-55, manufactured by DALTON CORPORATION) equipped with a screen having a diameter of 1.0 mm, and dried at 60° C. for 2 hours to remove water, thereby obtaining an agrochemical composition (granules). Table 5 below shows the makeup of the obtained agrochemical composition. In addition, agrochemical compositions (granules) produced with various water contents were obtained in the same manner except that the water content was 11%, 15%, or 16% (the makeups of the obtained agrochemical compositions were the same as the makeup of the agrochemical composition produced with a water content of 9%).

### Comparative Examples 7 to 10

Agrochemical compositions (granules) were obtained in the same manner as in Example 6, except that the makeups of the agrochemical compositions were changed as shown in Table 5 below, and the water content was changed to the amounts shown in Table 6 below. Note that the bentonite used in Table 5 was KUNIGEL V1 manufactured by KUNIMINE INDUSTRIES CO., LTD.

TABLE 5

| | | Comp. | Comp. | Comp. | Comp. |
|---|---|---|---|---|---|
| | Ex. 6 | Ex. 7 | Ex. 8 | Ex. 9 | Ex. 10 |
| Probenazole (purity: | 10.25 | 10.25 | 10.25 | 10.25 | 10.25 |
| 97.6%) | | | | | |
| Flupyrimin | 2.00 | 2.00 | 2.00 | 2.00 | 2.00 |
| Resin emulsion | 10.00 | 10.00 | 10.00 | 10.00 | 10.00 |
| (Mowinyl LDM7400P, | | | | | |
| powder) | | | | | |
| Organically modified | 3.00 | — | 3.00 | — | — |
| bentonite (KUNIVIS | | | | | |
| 127) | | | | | |
| Bentonite (KUNIGEL | — | — | — | — | 3.00 |
| V1) | | | | | |
| Oil (liquid | 5.00 | — | — | 5.00 | 5.00 |
| paraffin No. 260S) | | | | | |
| Surfactant | 0.30 | 0.30 | 0.30 | 0.30 | 0.30 |
| Binder | 0.50 | 0.50 | 0.50 | 0.50 | 0.50 |
| Filler | 68.95 | 76.95 | 73.95 | 71.95 | 68.95 |
| Total amount | 100.0 | 100.0 | 100.0 | 100.0 | 100.0 |

### (Manufacturability Test)

First, each of the agrochemical compositions obtained in Examples and Comparative Examples were sifted by using sieves having aperture sizes of 1.7 mm and 0.3 mm, and the ratio (fraction (%) by weight) of the total weight of particles having particle diameters of 1.7 mm or smaller and 0.3 mm or larger relative to the weight of the entire agrochemical composition was determined. Table 6 below shows the results. Note that “-” in Table 6 indicate that such an agrochemical composition was not prepared. In this test, when the water content is lower than the optimal amount, the fraction by weight of particles having particle diameters smaller than 0.3 mm increases. Meanwhile, when the water content exceeds the optimal amount, the fraction by weight of particles having particle diameters larger than 1.7 mm increases.

TABLE 6

| Water | | Comp. | Comp. | Comp. | Comp. |
|---|---|---|---|---|---|
| content (%) | Ex. 6 | Ex. 7 | Ex. 8 | Ex. 9 | Ex. 10 |
| 9 | 97.7 | — | — | — | 93.2 |
| 10 | — | — | — | 94.6 | — |
| 11 | 98.4 | 92.8 | — | 74.1 | 99.0 |
| 12 | — | — | — | 8.0 | — |
| 13 | — | — | 88.1 | — | 87.3 |
| 14 | — | 93.4 | — | — | 64.6 |
| 15 | 99.1 | 21.6 | — | — | — |
| 16 | 99.0 | 4.6 | 98.8 | — | — |

As shown in Table 6, the agrochemical composition of the present invention (for example, Example 6) 6 achieved fractions by weight (yields) of 97% or higher, when the water content was within a range as wide as at least 9 to 16%. In other words, it was found that the range of the optimal amount of the water content was so wide that the granules were obtained easily and highly efficiently, and the manufacturability was excellent. Meanwhile, regarding the agrochemical compositions (for example, Comparative Examples 7 to 10), which did not have the constitution according to the present invention, it was found that the range of the optimal amount of the water content (for example, a range where the fraction by weight is 95% or higher) was narrow or it was difficult to determine such an optimal amount, which made these agrochemical compositions difficult to produce, because strict control was required during the production, and granulation with a water content not within the optimal amount caused the granulated material to become powdery or caused granules of the granulated material to agglomerate.

### Example 7

First, a mixture was obtained by mixing 2.00 parts by mass of thiamethoxam (water solubility (25° C.): 4.1 g/L, purity: 100.0%, manufactured by Tokyo Chemical Industry Co., Ltd.), 10.00 parts by mass of a resin emulsion (acrylic resin emulsion (powder), ELOTEX TITAN7000, manufactured by Celanese Corporation), 20.00 parts by mass of a surface-treated kaolin (calcined kaolin surface-treated with a mercapto silane, Nucap 290W, manufactured by KaMin LLC), 3.00 parts by mass of an organically modified bentonite (bentonite surface-treated with a quaternary ammonium compound, KUNIVIS 127, manufactured by KUNIMINE INDUSTRIES CO., LTD.), 5.00 parts by mass of an oil (a vegetable oil, rapeseed oil, manufactured by FUJIFILM Wako Pure Chemical Corporation), 0.30 parts by mass of a surfactant (sodium lauryl sulfate (alkyl sulfate): EMAL 10PT, manufactured by Kao Corporation), 0.50 parts by mass of a binder (polyvinyl alcohol: KURARAY POVAL 44-885, manufactured by KURARAY CO., LTD.), and 59.20 parts by mass of a filler (clay, Showa Clay 70N, manufactured by Showa KDE Co., Ltd.) in a mixing apparatus (fiber mixer, manufactured by Panasonic Corporation). To the obtained mixture, a suitable amount of water was added, followed by kneading in a vertical kneader (Model: ACM08LVT-B, manufactured by AICOHSHA MFG. CO., LTD.). The obtained kneaded material was granulated by using Multi-Gran (Model: MG-55, manufactured by DALTON CORPORATION) equipped with a screen having a diameter of 1.0 mm, and dried at 60° C. for 2 hours to remove water, thereby obtaining an agrochemical composition (granules). Table 7 below shows the makeup of the obtained agrochemical composition.

### Comparative Examples 11 and 12

Agrochemical compositions (granules) were each obtained in the same manner as in Example 7, except that the makeup of the agrochemical composition was changed as shown in Table 7 below.

TABLE 7

| | Ex. 7 | Comp. Ex. 11 | Comp. Ex. 12 |
|---|---|---|---|
| Thiamethoxam | 2.00 | 2.00 | 2.00 |
| Resin emulsion (ELOTEX | 10.00 | 10.00 | — |
| TITAN7000, powder) | | | |
| Surface-treated kaolin (Nucap | 20.00 | — | — |
| 290W) | | | |
| Organically modified | 3.00 | — | — |
| bentonite (KUNIVIS 127) | | | |
| Oil (rapeseed oil) | 5.00 | — | — |
| Surfactant | 0.30 | 0.30 | 0.30 |
| Binder | 0.50 | 0.50 | 2.00 |
| Filler | 59.20 | 87.20 | 95.70 |
| Total amount | 100.0 | 100.0 | 100.0 |

### Example 8

An agrochemical composition (granules) was obtained in the same manner as in Example 7, except that (water solubility (20° C.): 480 mg/L, purity: 96.5%, manufactured by Tokyo Chemical Industry Co., Ltd.) was used instead of thiamethoxam, that Mowinyl LDM7400P (acrylic resin emulsion (powder), Mowinyl-Powder LDM7400P) manufactured by Japan Coating Resin co., ltd. was used as a resin emulsion, that Translink 445 (calcined kaolin surface-treated with an aminosilane) manufactured by BASF was used as a surface-treated kaolin, that KUNIVIS 110 (bentonite surface-treated with a quaternary ammonium compound) manufactured by KUNIMINE INDUSTRIES CO., LTD. was used as an organically modified bentonite, and that methyl oleate (hydrocarbon-based oil) manufactured by FUJIFILM Wako Pure Chemical Corporation was used as an oil. Table 8 below shows the makeup of the obtained agrochemical composition.

### Example 9 and Comparative Examples 13 to 14

Agrochemical compositions (granules) were each obtained in the same manner as in Example 8, except that the makeup of the agrochemical composition was changed as shown in Table 8 below.

TABLE 8

| | | | Comp. | Comp. |
|---|---|---|---|---|
| | Ex. 8 | Ex. 9 | Ex. 13 | Ex. 14 |
| Imidacloprid | 2.00 | 2.00 | 2.00 | 2.00 |
| Resin emulsion (Mowinyl | 10.00 | — | — | — |
| LDM7400P, powder) | | | | |
| Surface-treated | 20.00 | 20.00 | 20.00 | — |
| kaolin (Translink 445) | | | | |
| Organically modified | 3.00 | 3.00 | — | — |
| bentonite (KUNIVIS 110) | | | | |
| Oil (methyl oleate) | 5.00 | 5.00 | — | — |
| Surfactant | 0.30 | 0.30 | 0.30 | 0.30 |
| Binder | 0.50 | 2.00 | 2.00 | 2.00 |
| Filler | 59.20 | 67.70 | 75.70 | 95.70 |
| Total amount | 100.0 | 100.0 | 100.0 | 100.0 |

### Example 10

An agrochemical composition (granules) was obtained in the same manner as in Example 7, except that tebufloquin (water solubility (20° C.): 20.2 mg/L, purity: 98.8%, manufactured by MMAG Co., Ltd.) was used instead of thiamethoxam, that liquid paraffin No. 260S (hydrocarbon-based oil) manufactured by Sanko Chemical Industry Co., Ltd. was used as an oil, and that the makeup was changed as shown in Table 9 below.

### Examples 11 and Comparative Examples 15

Agrochemical compositions (granules) were each obtained in the same manner as in Example 10, except that the makeup of the agrochemical composition was changed as shown in Table 9 below.

TABLE 9

| | Ex. 10 | Ex. 11 | Comp. Ex. 15 |
|---|---|---|---|
| Tebufloquin | 1.50 | 1.50 | 1.50 |
| Resin emulsion (ELOTEX | 10.00 | 10.00 | — |
| TITAN7000, powder) | | | |
| Surface-treated kaolin (Nucap 290W) | 20.00 | — | — |
| Organically modified | 3.00 | 3.00 | — |
| bentonite (KUNIVIS 127) | | | |
| Oil (liquid paraffin No. 260S) | 5.00 | 5.00 | — |
| Surfactant | 0.30 | 0.30 | 0.30 |
| Binder | 0.50 | 0.50 | 2.00 |
| Filler | 59.70 | 79.70 | 96.20 |
| Total amount | 100.0 | 100.0 | 100.0 |

### Example 12

An agrochemical composition (granules) was obtained in the same manner as in Example 7, except that pretilachlor (water solubility (25° C.): 74 mg/L, purity: 97.9t, manufactured by Tokyo Chemical Industry Co., Ltd.) was used instead of thiamethoxam, that Mowinyl LDM7400P (acrylic resin emulsion (powder), Mowinyl-Powder LDM7400P) manufactured by Japan Coating Resin co., ltd. was used as a resin emulsion, that Translink 37 (calcined kaolin surface-treated with a vinylsilane) manufactured by BASF was used as a surface-treated kaolin, that S-BEN W (bentonite surface-treated with a quaternary ammonium compound) manufactured by HOJUN Co., Ltd. was used as an organically modified bentonite, and that liquid paraffin No. 260S (hydrocarbon-based oil) manufactured by Sanko Chemical Industry Co., Ltd. was used as an oil. Table 10 below shows the makeup of the obtained agrochemical composition.

### Examples 13 and 14 and Comparative Example 16

Agrochemical compositions (granules) were each obtained in the same manner as in Example 12, except that the constitution of the agrochemical composition was changed as shown in Table 10 below.

TABLE 10

| | | | | Comp. |
|---|---|---|---|---|
| | Ex. 12 | Ex. 13 | Ex. 14 | Ex. 16 |
| Pretilachlor | 2.00 | 2.00 | 2.00 | 2.00 |
| Resin emulsion (Mowinyl | 10.00 | — | 10.00 | — |
| LDM7400P, powder) | | | | |
| Surface-treated | 20.00 | 20.00 | 20.00 | — |
| kaolin (Translink 37) | | | | |
| Organically modified | 3.00 | 3.00 | — | — |
| bentonite (S-BEN W) | | | | |
| Oil (liquid paraffin No. 260S) | 5.00 | 5.00 | — | — |
| Surfactant | 0.30 | 0.30 | 0.30 | 0.30 |
| Binder | 0.50 | 2.00 | 0.50 | 2.00 |
| Filler | 59.20 | 67.70 | 67.20 | 95.70 |
| Total amount | 100.0 | 100.0 | 100.0 | 100.0 |

### (Release Test)

### [Thiamethoxam and Imidacloprid]

First, test containers (capacity: 100 mL) were each charged with 100 mL of deionized water, and allowed to stand in a thermostatic chamber, to raise the water temperature to 40° C. Subsequently, 500 mg of the agrochemical compositions obtained in Examples and comparative Examples were introduced into the test containers. Three hours after the introduction, the solution in each test container was gently shaken to make the solution uniform. Then, approximately 1 mL was taken, and filtered through a membrane filter having a pore diameter of 0.45 μm. The concentrations of the agrochemical active ingredients (thiamethoxam and imidacloprid) in the filtrate were measured by high performance liquid chromatography, and the concentration (released concentration (ppm)) of each of the agrochemical active ingredients in the test container at three hours post-introduction was calculated. Tables 11 and 12 below shows the results.

TABLE 11

| | Ex. 7 | Comp. Ex. 11 | Comp. Ex. 12 |
|---|---|---|---|
| Concentration of thiamethoxam | 90.7 | 98.3 | 99.0 |
| released after 3 hours (ppm) | | | |

TABLE 12

| | | | Comp. | Comp. |
|---|---|---|---|---|
| | Ex. 8 | Ex. 9 | Ex. 13 | Ex. 14 |
| Concentration of imidacloprid | 55.4 | 58.0 | 68.0 | 64.7 |
| released after 3 hours (ppm) | | | | |

### [Tebufloquin and Pretilachlor]

First, test containers (capacity: 200 mL) were each charged with 200 mL of deionized water, and allowed to stand in a thermostatic chamber, to raise the water temperature to 40° C. Subsequently, 250 mg of the tebufloquin-containing agrochemical compositions or 500 mg of the pretilachlor-containing agrochemical compositions obtained in Examples and Comparative Examples were introduced into the test containers. Three hours after the introduction, the solution in each test container was gently shaken to make the solution uniform. Then, approximately 1 mL was taken, and filtered through a membrane filter having a pore diameter of 0.45 μm. The concentration of each of the agrochemical active ingredients (tebufloquin and pretilachlor) in the filtrate was measured by high performance liquid chromatography, and the concentration (released concentration (ppm)) of each of the agrochemical active ingredients in the test container at three hours post-introduction was calculated. Tables 13 and 14 below show the results.

TABLE 13

| | Ex. 10 | Ex. 11 | Comp. Ex. 15 |
|---|---|---|---|
| Concentration of tebufloquin | 0.46 | 0.58 | 1.38 |
| released after 3 hours (ppm) | | | |

TABLE 14

| | | | | Comp. |
|---|---|---|---|---|
| | Ex. 12 | Ex. 13 | Ex. 14 | Ex. 16 |
| Concentration of pretilachlor | 2.43 | 3.98 | 2.62 | 11.75 |
| released after 3 hours (ppm) | | | | |

As shown in Tables 11 to 14, it was found that, as in the cases where probenazole and flupyrimin are used, the agrochemical compositions of the present invention (for example, Examples 7 to 14), in which thiamethoxam, imidacloprid, tebufloquin, or pretilachlor is used as the agrochemical active ingredient, each had a sufficiently low released concentration of the agrochemical active ingredient compared to the agrochemical composition comprising none of the resin emulsion, the surface-treated kaolin, the organically modified bentonite, and the oil according to the present invention (for example, Comparative Examples 12, 14, 15, or 16), and hence exhibited excellent sustained-release properties irrespective of the type of the agrochemical active ingredient. Meanwhile, it was found that the agrochemical compositions (for example, Comparative Examples 11 to 16), which did not contain two or more of the resin emulsion, the surface-treated kaolin, and the combination of the organically modified bentonite and the oil according to the present invention had high released concentrations irrespective of the type of the agrochemical active ingredient, and were inferior to the agrochemical compositions of the present invention in terms of sustained-release properties.

### INDUSTRIAL APPLICABILITY

According to the present invention, it is possible to provide a sustained-release agrochemical composition which is excellent in sustained-release properties and from which rapid release of the agrochemical active ingredient into water at an initial stage is sufficiently suppressed, and a production method that makes it possible to easily and highly efficiently obtain sustained-release agrochemical granules which are excellent in sustained-release properties and from which rapid release of the agrochemical active ingredient into water at an initial stage is sufficiently suppressed.

1. An agrochemical composition comprising:
two or more selected from the group consisting of the following three:
a resin emulsion;
a surface-treated kaolin; and
a combination of an organically modified bentonite and an oil; and
an agrochemical active ingredient.

2. The agrochemical composition according to claim 1, wherein
the resin emulsion is an acrylic resin emulsion.

3. The agrochemical composition according to claim 1, wherein
the surface-treated kaolin is a kaolin surface-treated with a silane.

4. The agrochemical composition according to claim 1, wherein
the organically modified bentonite is a bentonite surface-treated with a quaternary ammonium compound.

5. The agrochemical composition according to claim 1, wherein
the oil is at least one selected from the group consisting of hydrocarbon-based oils and vegetable oils.

6. The agrochemical composition according to claim 1, which comprises an agrochemical active ingredient having a water solubility at 20 to 25° C. of 50 g/L or lower as the agrochemical active ingredient.

7. The agrochemical composition according to claim 1, further comprising at least one selected from the group consisting of surfactants and fillers.

8. The agrochemical composition according to claim 1, which is in the form of granules.

9. A method for producing the agrochemical composition according to claim 8, comprising a step of mixing and granulating two or more selected from the group consisting of the following three:
the resin emulsion;
the surface-treated kaolin; and
the combination of the organically modified bentonite and the oil;
with the agrochemical active ingredient.

10. A method for producing the agrochemical composition according to claim 8, comprising:
a granulation step of mixing and granulating two or more selected from the group consisting of the following three:
the resin emulsion;
the surface-treated kaolin; and
the combination of the organically modified bentonite and the oil; and
a step of introducing the agrochemical active ingredient into a granulated material obtained in the granulation step.
